(19) United States
(12) Patent Application Publication
(10) Pub. No.: US 2018/0258312 A1
(43) Pub. Date: Sep. 13, 2018

(54) COMPOSITIONS FOR MAKING DRY-ERASABLE COATINGS

(71) Applicant: CONSORCIO COMEX S.A. DE C.V., Distrito Federal (MX)

(72) Inventors: Jaime Cordero Basave, Distrito Federal (MX); María Guadalupe Perez Caballero, Distrito Federal (MX)

(21) Appl. No.: 15/456,607

(22) Filed: Mar. 13, 2017

(51) Int. Cl. C09D 163/00; C09D 5/00; B43L 1/00

(52) U.S. Cl. CPC C09D 163/00; B43L 1/002; C09D 5/00

(57) ABSTRACT

Disclosed is a dry-erasable coating composition comprising (a) a resin component comprising (i) an epoxy silane resin; and (ii) a cycloaliphatic epoxy resin different from the resin of (a)(i) and (b) an amino-functional crosslinking agent. A substrate at least partially coated with the dry-erasable coating composition and a method of making a dry-erasable surface are also described herein.

### FIELD OF THE INVENTION

The present invention relates to a curable coating composition that when applied to a surface and cured forms a dry-erasable coating on the surface.

### BACKGROUND OF THE INVENTION

Dry-erasable coatings may be produced from liquid coating compositions that when applied to a surface and dried and/or cured, produce a coating having dry-erasable characteristics. Such dry-erasable coatings (often referred to as “white board paint”) when applied to a substrate can function in the manner of a traditional “white board”, typically a metal, plastic, or particle board coated with a resin such as a melamine-based resin. Marker ink can be wiped off white boards and dry-erasable coatings so that the surface thereof may be reused.

Important properties of dry-erasable coating compositions include ease of application to walls and other substrates by consumers, use of environmentally friendly components, and ease of erasing markings with little or no residual visual markings. Certain dry-erasable coating compositions are produced using isocyanate-functional crosslinkers, which present potential health and environmental hazards, are not suitable for use by consumers in the do-it-yourself market.

### SUMMARY OF THE INVENTION

The present invention is directed to a dry-erasable coating composition comprising (a) a resin component comprising (i) an epoxy silane resin; and (ii) a cycloaliphatic epoxy resin different from the resin of (a)(i) and (b) an amino-functional crosslinking agent. A substrate at least partially coated with the dry-erasable coating composition and a method of making a dry-erasable surface are also described herein.

### DESCRIPTION OF THE INVENTION

For the purposes of the following detailed description, it is to be understood that the invention may assume various alternative variations and step sequences, except where expressly specified to the contrary. It is also to be understood that the specific compositions, coated substrates, multilayer coatings and methods described in the following specification are simply exemplary embodiments of the invention. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

The present invention is generally directed to dry-erasable coating compositions also referred to as white board paint, which when applied to a substrate and cured, exhibit suitable hydrophobicity, resilience, hardness, erasability, roughness, and/or gloss, to render the cured coating composition suitable as a dry erasable surface.

In general, a cured coating composition as described herein is considered to be a “dry-erase” or “write-erase”, which terms are used interchangeably, if it can be written upon using a marking materials and subsequently removed without use of solvent with minimal effort such as by wiping with a cloth or other fibrous material that may be disposable or provided on a reusable eraser. A surface is considered to be “write-erase” or “dry-erase” if a marking material can be erased from the surface to be substantially invisible, resulting in little or no ghosting (shadowy appearance of prior markings), even after prolonged normal use at the same location, for example, after 10 cycles (e.g., after 50 cycles, after 100 cycles, after 500 cycles, after 1,000 cycles, after 2,000 cycles, after 3,000 cycles, after 4,000 cycles, after 5,000 cycles, after 6,000 cycles, after 7,000 cycles, after 8,000 cycles, or after 9,000 cycles) of writing and erasing at the same position and/or have desired performance in specific write-erase tests. By “substantially invisible” it is meant that one viewing the surface with the naked eye would not detect the marking material. A “dry-erase”/“write-erase” material as described herein may be characterized by one or more of the characteristics described herein. As described herein, marking materials include markers produced commercially for the dry-erase market, such as EXPO® markers that typically contain a solvent dispersed pigment. Due the solvent present in such markers, hydrophobicity of the dry-erasable surface is desired to minimize penetration of the solvent and any pigment therewith into the surface.

As used herein, “cycloaliphatic” means non-aromatic cyclic compounds, such as those having 6 carbon atoms.

As used herein, “epoxy” means an epoxy or polyepoxide polymer, including monomers or short chain polymers with an epoxide group at either end.

“Alkyl” as used herein, refers to a saturated or unsaturated hydrocarbon containing 1-20 carbon atoms including both acyclic and cyclic structures (such as methyl, ethyl, propyl, isopropyl, butyl, iso-butyl, sec-butyl, pentyl, hexyl, cyclopropyl, cyclobutyl, cyclopentyl, cyclohexyl, propenyl, butenyl, cyclohexenyl, and the like). A linking divalent alkyl group is referred to as an “alkylene” (such as ethylene, propylene, and the like).

As used herein, “alkoxy” refers to an -0-alkyl group. Example alkoxy groups include methoxy, ethoxy, propoxy (e.g., n-propoxy and isopropoxy), t-butoxy, and the like.

A “polyurethane” as used herein is a polymeric or oligomeric material that includes a urethane linkage in its backbone.

As used herein, in reference to acrylic components, “(meth)acrylate” and like terms refers both to the acrylate and the corresponding methacrylate. The term “(meth)acryloyl” and like terms refers both to the acryloyl and the corresponding methacryloyl. Also, “(meth)acrylamide” and like terms refers both to the acrylamide and the corresponding methacrylamide.

Herein, the term “silane” refers to a compound derived from SiH4 by substituting organic groups for at least some of the hydrogen atoms, and the term “alkoxy” refers to an —O-alkyl group. Further, an “alkoxysilane” refers to a silane compound with at least one alkoxy group bonded to a silicon atom. By “polysiloxane”, it is meant to include a component including a functional group with an Si—O—Si linkage.

As used herein, a “hydrocarbon” refers to a group formed from hydrogen and carbon atoms. The hydrocarbon can include a linear, branched, and/or cyclic hydrocarbon group.

As used herein, “curing” and like terms as used herein, refers to a process of setting (e.g., by evaporation (drying) and/or cross-linking) a material to form a coating on a substrate. Curing may include and/or is performed by exposure to ambient conditions, heat, radiation, and/or by cross-linking (e.g., oxidative cross-linking).

Further, the term “polymer” refers to oligomers and homopolymers (e.g., prepared from a single monomer species), copolymers (e.g., prepared from at least two monomer species), polymers prepared with more than two, such as three (a “terpolymer”), or more than three monomer species, and graft polymers. The term “resin” is used interchangeably with “polymer.”

Unless otherwise indicated, as used herein, “substantially free” means that a particular material is not purposefully added to a composition and only is present in trace amounts or as an impurity.

As used herein, the term “completely free” means that a composition does not comprise a particular material. That is, the composition comprises zero weight percent of such material.

The dry-erasable coating compositions of the present invention are generally two component systems including (a) a resin component and (b) a crosslinking or cure component. The coating compositions are substantially, or, in some cases, completely free of isocyanate functional compounds. As to the substantial absence of isocyanate functional compounds in the coating compositions of the present invention, “substantially free”, means that isocyanate functional compounds are present in the coating compositions of the present invention in an amount less than 1 percent by weight (wt. %), such as no more than 0.5 wt. %, or, in some cases, no more than 0.1 wt. %, based on the total resin solids weight of the coating composition. As used herein, the term “isocyanate functional compounds” refers to compounds comprising at least one, in some cases, two or more, isocyanate (NCO) functional groups per molecule.

The dry-erasable coating composition of the present invention comprises (a) a resin component comprising (i) an epoxy silane resin; and (ii) a cycloaliphatic epoxy resin different from the resin of (a)(i) and (b) an amino-functional crosslinking agent.

### (a) Resin Component

The resin component may include the reaction product of (i) an epoxy silane and (ii) a cycloaliphatic epoxy resin different from the epoxy silane (i) as disclosed in U.S. Pat. No. 9,540,542, incorporated herein by reference in its entirety. By “cycloaliphatic” it is meant non-aromatic cyclic compounds. The epoxy silane (a)(i) may be obtained by an etherification reaction of an epoxy-functional silane with the general formula:

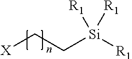

where each R₁ is independently selected from methyl, methoxy, ethoxy or propoxy; “X” can be an epoxy-cyclohexyl or glycidoxy group; and “n” is an integer between 1 and 6, with a hydrogenated bisphenol with the general formula:

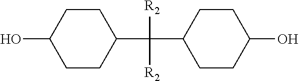

where each R₂ can be methyl, ethyl or hydrogen.

The epoxy-functional silane is between 30 and 75%, or from 50 to 65% by weight of the total components of the cycloaliphatic resin and the hydrogenated bisphenol is from 30 to 70%, or from 35 to 65% by weight of the total components of the cycloaliphatic resin. Suitable hydrogenated bisphenols include hydrogenated bisphenol A and/or hydrogenated bisphenol F.

The epoxy-functional silane comprises a glycidyl function at one end and methoxy, ethoxy or propoxy radicals linked to the silicon of the epoxy-functional silane. Suitable epoxy-functional silanes include 3-glycidyloxy-propyl-trimethoxy-silane, 3-glycidyloxy-propyl-triethoxy-silane, γ-glycidoxy-propyl-triethoxy-silane, 3-glycidyloxy-propyl-tripropoxy-silane, 3-glycidoxy-propyl-methyl-diethoxy-silane, 2-(3,4 epoxy-cyclohexyl)ethyl-trimethoxy-silane, and/or β-(3,4 epoxy-cyclohexyl)ethyl-triethoxy-silane.

The etherification reaction may be carried out at low temperature in a range from 90° C. to 160° C., in the presence of an organometallic catalyst. As a product of this reaction, an alcohol is generated, which corresponds to the type of epoxy-functional silane used, from 70 to 90% of the expected theoretical stoichiometric value is extracted, methoxy functionalized silanes may produce higher yields.

The cycloaliphatic rings of the hydrogenated bisphenol impart superior mechanical and chemical properties to the molecule when combined with the epoxy-functional silane by alcoholysis between hydroxyl end groups of the hydrogenated bisphenol and the methoxy, ethoxy or propoxy end groups of the epoxy-functional silane, providing an oxirane end group to the molecule, which can react with amine or amino-silane hardeners, and one or more methoxy or ethoxy moieties are available for combination with other functional groups to enable it to form hybrids with e.g. polysiloxanes, acrylics or epoxies.

The etherification reaction can be carried out in a molar ratio of 0.7:1.0 to 2.5:1.0 between the epoxy-functional silane and the hydrogenated bisphenol, such as one or two molecules of the epoxy-functional silane per mole of hydrogenated bisphenol. By using a higher molar ratio of epoxy-functional silane more end groups are available, forming a denser and stronger linking with the versatility of having the option of forming hybrids with other type of resins.

An epoxy-functional silane having at least two end groups methoxy, ethoxy or propoxy available in the molecule can react with the hydroxyl groups of the hydrogenated bisphenol. In this reaction an alcohol is generated, which corresponds to the type of epoxy-functional silane used, the alcohol must be extracted since the reaction is reversible. The reaction for obtaining the cycloaliphatic resin is promoted by organometallic catalysts such as zinc octoate or tin laureate. Due to the type of components used in obtaining the cycloaliphatic resin the addition of water is not required.

The cycloaliphatic epoxy resin may be cyclohexane dimethanol and diglycidyl ethers of hydrogenated bisphenol A-type epoxide resin, such as KUDKO ST 3000 from Kukdo Chemical Co. Ltd. in Seoul, Korea, EPON DPL-862, Eponex 1510, HELOXY 107 and EPONEX 1513 (hydrogenated bisphenol A-epichlorohydrin epoxy resin) from Shell Chemical in Houston, Tex.; SANTOLINK LSE-120 from Monsanto in Springfield, Mass.; EPODIL 757 (cyclohexane dimethanol digylcidylether) from Pacific Anchor located in Allentown, Pa.; ARALDITE XUGY358 and PY327 from Ciba Geigy in Hawthorne, N.Y.; EPIREZ 505 from Rhone-Poulene in Louisville, Ky.; Aroflint 393 and 607 from Reichold in Pensacola, Fla.; and ERL4421 from Union Carbide in Tarrytown, N.Y. Other suitable non-aromatic epoxy resin include DER 732 and DER 736.

Of the total resin component, the epoxy silane resin may comprise at least 35 wt. % or at least 40 wt. % or at least 45 wt. % and up to 55 wt. % or up to 60 wt. % or up to 65 wt. %., and the cycloaliphatic epoxy resin may comprise at least 10 wt. % or at least 20 wt. % and up to 30 wt. % or up to 35 wt. %. As such, the resin component may include the epoxy silane resin in a range of 35-65 wt. % or 40-60 wt. % or 45-55 wt. %, with the cycloaliphatic resin present in a range of 10-35 wt. % or 20-30 wt.%, with the balance being solvent and additives.

The resin component may comprise at least 30 wt. % or at least 40 wt. % or at least 50 wt. % and up to 90 wt. % or up to 80 wt. % or up to 70 wt. % of the dry-erasable coating composition based on the total solid weight of the coating composition. The epoxy silane resin may comprise at least 2 wt. % or at least 5 wt. % or at least 10 wt. % and up to 75 wt. % or up to 50 wt. % or up to 35 wt. % of the coating composition based on total solids. The resin component may comprise a range of 30-90 wt. % or 40-80 wt. % or 50-70 wt. % with the silane resin comprising a range of 2-75 wt. % or 5-50 wt. % or 10-35 wt. % of the dry-erasable coating composition.

Optionally, the resin component may further include an alkyl silicate. The alkyl silicate may have methyl, ethyl, propyl, butyl, or hydroxyl end groups that can readily react with the un-reacted end groups methoxy, ethoxy, or propoxy of the etherification reaction between the hydrogenated bisphenol and the epoxy-functional silane. The alkyl silicate may include tetramethyl orthosilicate, tetraethyl orthosilicate, tetrapropyl orthosilicate and/or tetrabutyl orthosilicate, wherein the alkyl-silicates can be hydrolyzed or partially hydrolyzed.

Optionally, the resin component may further comprise an acrylic resin, which may or may not impact the dry-erasable properties of the coating composition. The acrylic resin may be included as a low cost non-reactive or reactive polymeric diluent to minimize the cost of the coating composition. The acrylic resin may comprise a homopolymer or copolymer or terpolymer produced from acrylic monomers including methyl(meth)acrylate, ethyl(meth)acrylate, propyl(meth)acrylate, butyl(meth)acrylate, hydroxyl propyl(meth)acrylate, hydroxyl butyl(meth)acrylate, and combinations thereof. For example, the acrylic resin may comprise a hydroxyl functional terpolymer resin produced from hydroxy ethyl acrylate, butyl acrylate and methyl methacrylate. It is believed that the hydroxyl groups of the terpolymer may react with alkoxy groups in the resin component. If present, of the total resin component, the acrylic resin may comprise a range of 5-40 wt. % or 10-30 wt. %. The acrylic resin may comprise a range of 2-30 wt. % of the coating composition based on total solids.

### (b) Crosslinking Agent

The amino-functional polysiloxane crosslinking agent may include a primary amine functional polysiloxane, such as those having a general structure of:

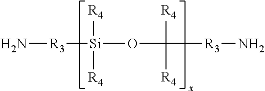

in which each R₃ may be a difunctional organic radical independently comprising aryl, alkyl, dialkylaryl, alkoxyalkyl, alkylaminoalkyl, and cycloalkyl radicals, each R₄ may independently comprise aryl, phenyl, (C₁-C₄) alkyl, (C₁-C₄) alkoxy groups, —OSi(R₅)₂R₃NH₂, —OSi(O_{1/2})(R₄)R₅, —OSi(O_{1/2})(R₄)₂R₃NH₂, —OSi(O_{1/2})(R₅)₂, —OSi(O_{1/2})(R₅)R₃NH₂, —OSi(O_{1/2})₂R₅, —OSi(O_{1/2})₂R₃NH₂, —OSi(O_{1/2})₂R₄, —OSi(R₅)₃, or —OSi(R₅)₂R₄, where O_{1/2} refers to an oxygen that is bonded to (shared by) two silicon atoms in the polysiloxane and each R₅ may independently comprise aryl, phenyl, (C₁-C₄) alkyl, or (C₁-C₄) alkoxy groups. The polysiloxane may have a structure where x is 1 to 30, such as 10 to 20. In some cases, x is selected so that the polysiloxane has an amine equivalent weight ranging from about 100 to about 1,000, such as 200 to 500. Each R₄ may be independently selected from phenyl, methyl, methoxy groups or —OSi(R₅)₂R₃NH₂, —OSi(O_{1/2})(R₄)R₅, —OSi(O_{1/2})(R₄)₂R₃NH₂, —OSi(O_{1/2})(R₅)₂, —OSi(O_{1/2})(R₅)R₃NH₂, —OSi(O_{1/2})₂R₅, —OSi(O_{1/2})₂R₃NH₂, —OSi(O_{1/2})₂R₄, —OSi(R₅)₃, —OSi(R₅)₂R₄, or may be methyl or phenyl groups. For example, at least one R₄ may be methyl, at least one R₄ may be methoxy, at least one R₄ may be phenyl, at least one R₄ may be —OSi(R₅)₂R₃NH₂, at least one R₄ may be —OSi(O_{1/2})(R₄)R₅, at least one R₄ may be —OSi(O_{1/2})(R₄)₂R₃NH₂, at least one R₄ may be —OSi(O_{1/2})(R₅)₂, at least one R₄ may be —OSi(O_{1/2})(R₅)R₃NH₂, at least one R₄ may be —OSi(O_{1/2})₂R₅, at least one R₄ may be —OSi(O_{1/2})₂R₃NH₂, at least one R₄ may be —OSi(O_{1/2})₂R₄, at least one R₄ may be —OSi(R₅)₃, and at least one R₄ may be —OSi(R₅)₂R₄. The amino-functional polysiloxane may have a structure where R₄ includes greater than 70% of phenyl group substitution, less than 30% (C₁-C₄) alkyl group substitution and less than 2.0% (C₁-C₄)alkoxy group substitution or less than 0.5% of (C₁-C₄)alkoxy group substitution. The primary amino-functional polysiloxane may have an amine equivalent weight of 230 to 280 g/NH, or 240 to 280 g/NH or 250 to 270 g/NH. The primary amino-functional polysiloxane may be SILRES® HP2000 an amino functional, methyl phenyl silicone resin, having an amine equivalent weight of 230-255, commercially available from Wacker Chemical Corporation, Adrian, Mich. Other suitable amino-functional polysiloxanes include DOW CORNING® 3055 Resin, a flexible amino-functional phenyl methyl silicone resin (CAS No. 1242619-23-3), having an amine equivalent of 250-270 grams/NH, commercially available from Dow Corning Corp., Midland, Mich.

Optionally, the cross-linking agent may further include a secondary curing agent, such as a hydroxyl alkyl urethane having the general formula

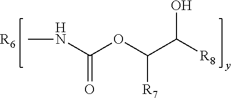

where R₆, R₇, and R₈ are each selected from hydrogen and (C₁-C₆) alkyl groups; R₆ may also be an alkyldiaminoalkyl and n is at least 2. Of the total cure component, the amino functional crosslinking agent may comprise 70-99 wt. % and 0.1-2 wt. % of secondary curing agent, with the balance being solvent, catalyst and additives.

The crosslinking agent may comprise 20-60 wt. % or 30-50 wt. % of the dry-erasable coating composition based on total solids. If present, the secondary crosslinking agent may comprise up to 2 wt. % or up to 1 wt. % of the coating composition based on total solids. The secondary crosslinking is believed to enhance the curing properties of the coating composition resulting in good flexibility.

The coating compositions of the present invention may include other non-reactive components such as fillers, surfactants, pigments, defoaming agents, rheology agents, dispersants, fragrances, flame retardants, biocides, UV and/or IR protectants (reflectors), and light stabilizers.

The dry erasable coating composition may include solids in an amount based on the total composition of at least 70 wt. % or 75 wt. % or 80 wt. % or 85 wt. %, with solids volume based on total volume of at least 50 vol. % or 60 vol. % or 70 vol. % or 80 vol. %. Total volatile organic content (VOC) may be less than 80 g/L or 75 g/L or 70 g/L as determined by ASTM D3960-05.

When the dry-erasable coating composition of the present invention is applied to a substrate and cured, the resulting coating exhibits dry erasability as determined by writing upon a coated surface with a marking material comprising a colorant and a solvent, the solvent comprising one or more of water, alcohols, esters, acetates, mineral spirits, or mixtures thereof, the marking material can be erased from the surface of the write-erasable material to be substantially invisible for more than 100 or more than 1000 cycles of writing and erasing at the same position; likewise the marking material can be erased from the surface of the write-erasable material to be substantially invisible after one day, one week, one moth, three months, six months, nine months or 12 months of writing.

Suitable substrates onto which the coating compositions of the present invention may be applied include walls and framed materials, which may be comprised of wood, wallboard (e.g. gypsum), fiber board, particle board (e.g. wood chip based), cellulose-based board (e.g. cardboard), fabric and the like. The substrate may be uncoated or be previously coated with a coating composition (such as a conventional architectural paint) comprising resins having acrylic, vinyl, styrene, epoxy and/or polysiloxane groups. The coating composition is applied to the substrate (including coated substrate) at ambient temperature and typically cured within 1 to 12 hours, and is ready for use as a dry-erasable surface in 2 days.

The dry-eraseable coating composition comprising a resin component and a cure component may be provided with the two components in separate containers in a proportional ratio of two parts of resin component to one part of curing component by volume. In use, the components are mixed together and may be applied to a substrate using short nap chemically resistant rollers, or via brushing or spraying, to a total wet film thickness of 4 to 6 mils per coat. One coat may be sufficient to provide a dry writable-eraseable coating. In certain instances, a second light coat may be warranted, building a total 6 to 8 mils thickness when dried. The coating composition of the present invention is suited for application to a cured coating composition such as an architectural coating that can serve as an underlayer, which may be pigmented, such as white colored. The coating composition of the present invention may be transparent such that the underlying layer (e.g. the white architectural paint) is visible therethrough. In two days, the dried coating is ready for receiving writing of commercial white board markers and erased without leaving any ghost marks after scrubbing with a soft cloth.

Illustrating the invention are the following examples that are not to be considered as limiting the invention to their details. All parts and percentages in the examples, as well as throughout the specification, are by weight unless otherwise indicated.

### EXAMPLES

### Example 1

Resin Component

In a clean and dry tank, 50 kilograms of epoxy-polysiloxane resin, 25 kilograms of hydrogenated BPA type epoxy resin and 13.9 kilograms of an acrylic resin were added and stirred at 600 rpm, 0.37 kilo grams of antifoam was then added to the tank, the revolutions were increased to 1200 and the mixture was stirred for 20 minutes. 0.85 kilograms of AEROSIL R-972 was added to the tank, upon completion 16.24 kilograms of ter-butyl acetate was added. The mixture was stirred for 20 minutes at 800 rpm until full incorporation of the components. The final mixture was filtered and packed with stirring and covered container.

Cure Component

In a clean and dry tank with lid, it was added without stir 38.4 kilograms of SILRES HP 2000, after completion the SILRES HP 2000 was stirred at 600 RPM and 0.75 kilograms of dibutyltin diacetyl acetonate, 7.75 kilograms of ter-butyl acetate and 5.95 kilograms of PRIFER 6813 were added to the tank; upon completion the stir was held for 15 minutes at 600 rpm.

The dibutyltin diacetyl acetonate was warmed up for melting before to be added to the tank. The tank was kept closed during and after mixing to avoid moisture contact.

### Example 2

Resin Component

In a clean and dry tank, 50 kilograms of epoxy-polysiloxane resin, 25 kilograms of hydrogenated BPA type epoxy resin and 13.9 kilograms of an acrylic resin were added and stirred at 600 rpm, 0.37 kilo grams of antifoam were then added to the tank, the revolutions were increased to 1200 and the mixture was stirred during 20 minutes. 0.85 kilograms of AEROSIL R-972 were added to the tank, upon completion it was added 16.24 kilograms of ter-butyl acetate. The mixture was stirred for 20 minutes at 800 rpm until full incorporation of the components. The final mixture was filtered and packed with stirring and covered tank.

Cure Component

In a clean and dry tank with lid, it was added without stir 54.19 kilograms of SILRES HP 2000, after completion the SILRES HP 2000 was stirred at 600 RPM and 0.65 kilograms of dibutyltin diacetyl acetonate, 0.82 kilograms of zinc octoate and 0.12 kilograms of ter-butyl acetate were added to the tank; upon completion the stir was held for 15 minutes at 600 rpm. The dibutyltin diacetyl acetonate was warmed up for melting before to be added to the tank. The tank was kept closed during and after mixing to avoid moisture contact.

### Example 3

Resin Component

In a clean and dry tank, 50 kilograms of epoxy-polysiloxane resin, 25 kilograms of hydrogenated BPA type epoxy resin and 13.9 kilograms of an acrylic resin were added and stirred at 600 rpm, 0.37 kilo grams of antifoam were then added to the tank, the revolutions were increased to 1200 and the mixture was stirred during 20 minutes. 0.85 kilograms of AEROSIL R-972 were added to the tank, upon completion it was added 16.24 kilograms of ter-butyl acetate. The mixture was stirred for 20 minutes at 800 rpm until full incorporation of the components. The final mixture was filtered and packed with stirring and covered tank.

Cure Component

In a clean and dry tank with lid, it was added without stir 54.19 kilograms of SILRES HP 2000, after completion the SILRES HP 2000 was stirred at 600 RPM and 0.65 kilograms of K-KAT XC-9213 and 0.82 kilograms of zinc octoate were added to the tank; upon completion the stir was held for 15 minutes at 600 rpm. The tank was kept closed during and after mixing to avoid moisture contact.

### Example 4

Resin Component

In a clean and dry tank, 13.82 kilograms of epoxy-polysiloxane resin, 40.0 kilograms of hydrogenated BPA type epoxy resin and 18.52 kilograms of an acrylic resin were added and stirred at 600 rpm, 0.37 kilograms of antifoam were then added to the tank, the revolutions were increased to 1200 and the mixture was stirred during 20 minutes. 16.27 kilograms of PRIFER 6813 were added to the tank, upon completion it was added 16.24 grams of ter-butyl acetate. The mixture was stirred for 20 minutes at 800 rpm until full incorporation of the components. The final mixture was filtered and packed with stirring and covered container.

Cure Component

In a clean and dry tank with lid, it was added without stir 48.72 kilograms of SILRES HP 2000, after completion the SILRES HP 2000 was stirred at 600 RPM and 0.75 kilograms of dibutyltin diacetyl acetonate, 0.75 kilograms of zinc octoate and 4.36 kilograms of ter-butyl acetate were added to the tank; upon completion the stir was held for 15 minutes at 600 rpm. The dibutyltin diacetyl acetonate was warmed up for melting before to be added to the tank. The tank was kept closed during and after mixing to avoid moisture contact.

### Example 5

Resin Component

In a clean and dry tank, 13.82 kilograms of epoxy-polysiloxane resin, 40.0 kilograms of hydrogenated BPA type epoxy resin and 42.15 kilograms of an acrylic resin were added and stirred at 600 rpm, 0.37 kilograms of antifoam were then added to the tank, the revolutions were increased to 1200 and the mixture was stirred during 20 minutes. 0.54 kilograms of BYK 320 and 13 kilograms of PRIFER 6813 were added to the tank. The mixture was stirred for 20 minutes at 800 rpm until full incorporation of the components. The final mixture was filtered and packed with stirring and covered container.

Cure Component

In a clean and dry tank with lid, it was added without stir 48.72 kilograms of SILRES HP 2000, after completion the SILRES HP 2000 was stirred at 600 RPM and 0.75 kilograms of dibutyltin diacetyl acetonate, 0.75 kilograms of zinc octoate and 4.36 kilograms of ter-butyl acetate were added to the tank; upon completion the stir was held for 15 minutes at 600 rpm. The dibutyltin diacetyl acetonate was warmed up for melting before to be added to the tank. The tank was kept closed during and after mixing to avoid moisture contact.

### Example 6

Resin Component

In a clean and dry tank, 549.99 kilograms of epoxy-polysiloxane resin and 269.99 kilograms of hydrogenated BPA type epoxy resin were added and stirred at 600 rpm, 6.26 kilograms of antifoam were then added to the tank, the revolutions were increased to 1200 and the mixture was stirred during 20 minutes. 218.32 kilograms of ter-butyl acetate were added to the tank. The mixture was stirred for 20 minutes at 800 rpm until full incorporation of the components. The final mixture was filtered and packed with stirring and covered container.

Cure Component

In a clean and dry tank with lid, it was added without stir 541.95 kilograms of SILRES HP 2000, after completion the SILRES HP 2000 was stirred at 600 RPM and 6.56 kilograms of dibutyltin diacetyl acetonate, 8.2 kilograms of zinc octoate and 1.23 kilograms of ter-butyl acetate were added to the tank; upon completion the stir was held for 15 minutes at 600 rpm. The dibutyltin diacetyl acetonate was warmed up for melting before to be added to the tank. The tank was kept closed during and after mixing to avoid moisture contact.

### Example 7

Resin Component

In a clean and dry tank, 549.97 kilograms of epoxy-polysiloxane resin and 269.99 kilograms of hydrogenated BPA type epoxy resin were added and stirred at 600 rpm, 8 kilograms of antifoam were then added to the tank, the revolutions were increased to 1200 and the mixture was stirred during 20 minutes. 216.86 kilograms of ter-butyl acetate were added to the tank. The mixture was stirred for 20 minutes at 800 rpm until full incorporation of the components. The final mixture was filtered and packed with stirring and covered container.

Cure Component

In a clean and dry tank with lid, it was added without stir 539.25 kilograms of SILRES HP 2000, after completion the SILRES HP 2000 was stirred at 600 RPM and 8.19 kilograms of dibutyltin diacetyl acetonate, 8.19 kilograms of zinc octoate and 2.62 kilograms of a nonisocyanate urethane modified amine hardener were added to the tank; upon completion the stir was held for 15 minutes at 600 rpm. The dibutyltin diacetyl acetonate was warmed up for melting before to be added to the tank. The tank was kept closed during and after mixing to avoid moisture contact.

### Comparative Example A

Resin Component

In a clean and dry tank, 523.35 kilograms of hydrogenated BPA type epoxy resin and 187.5 kilograms of an epoxy resin were added and stirred at 600 rpm, 11.38 kilograms of antifoam was then added to the tank, the revolutions were increased to 1200 and the mixture was stirred for 20 minutes. 15.0 kilograms of AEROSIL R-972 was added to the tank, upon completion 6.0 kilograms of DISPERBYK 163, 10.0 kilograms of DISPARLON 6500/DISLON 6500, 150 kilograms micronized barite, 10 kilograms of TINUVIN 292 , 26.53 kilograms of TEGO PROTECT 5001, 17.2 kilograms of ORGASOL 2001 EX D NAT, 39.16 kilograms of SILBOND CONDENSED, 123.26 kilograms of GLYMO DINASYLAN, 16.18 kilograms of dibutyltin diacetyl acetonate, 15.18 kilograms of zinc octoate 8%, 3.0 kilograms of TEGO GLIDE 410, 5.7 kilograms of water, and 59.95 kilograms of PLURASOLV EB were added. The mixture was stirred for 20 minutes at 800 rpm until full incorporation of the components. The final mixture was filtered and packed with stirring and covered container.

Cure Component

In a clean and dry tank with lid, it was added without stir 334.8 kilograms of SILRES HP 2000, after completion the SILRES HP 2000 was stirred at 600 RPM and 79.51 kilograms of nonisocyanate urethane modified amine hardener B and 121.33 kilograms of PRIFER 6813 were added to the tank; upon completion the stir was held for 15 minutes at 600 rpm.

A summary of the components included in Examples 1-7 and Comparative Example A is provided in Table 1.

TABLE 1

| | Example | | | | | | | Comp. |
|---|---|---|---|---|---|---|---|---|
| Components | 1 | 2 | 3 | 4 | 5 | 6 | 7 | Ex A |

RESIN COMPONENTS (grams)

| | | | | | | | | |
|---|---|---|---|---|---|---|---|---|
| Epoxy-polysiloxane resin ¹ | 47.00 | 47.00 | 47.00 | 13.13 | 12.58 | 52.65 | 52.64 | |
| KUKDO ST-3000 ² | 23.50 | 23.50 | 23.50 | 38.01 | 36.40 | 25.85 | 25.84 | 42.92 |
| D.E.R. 331 ³ | | | | | | | | 15.38 |
| TINUVIN 292 ⁴ | | | | | | | | 0.82 |
| Acrylic resin ⁵ | 13.08 | 13.08 | 13.08 | 17.60 | 38.36 | | | |
| FOAMTROL ⁶ | 0.35 | 0.35 | 0.35 | 0.36 | 0.34 | 0.60 | 0.77 | 0.93 |
| BYK-320 ⁷ | | | | | 0.50 | | | |
| DISPERBYK 163 ⁸ | | | | | | | | 0.49 |
| Micronized barite | | | | | | | | 12.30 |
| AEROSIL R-972 ⁹ | 0.80 | 0.80 | 0.80 | | | | | 1.23 |
| DISPARLON 6500/DISLON | | | | | | | | 0.82 |
| 6500 ¹⁰ | | | | | | | | |
| SILBOND CONDENSED ¹¹ | | | | | | | | 3.21 |
| GLYMO DINASYLAN ¹² | | | | | | | | 10.11 |
| TEGO PROTECT 5001 ¹³ | | | | | | | | 2.18 |
| TEGO GLIDE 410 ¹⁴ | | | | | | | | 0.25 |
| PRIFER 6813 ¹⁵ | | | | 15.47 | 11.83 | | | |
| NIAX CATALYST U-220 ¹⁶ | | | | | | | | 1.33 |
| Zinc octanoate 8% | | | | | | | | 1.25 |
| t-Butyl acetate | 15.27 | 15.27 | 15.27 | 15.43 | | 20.90 | 20.76 | |
| ORGASOL 2001 EXD NAT ¹⁷ | | | | | | | | 1.41 |
| Water | | | | | | | | 0.47 |
| PURASOLV EB ¹⁸ | | | | | | | | 4.92 |

CURE COMPONENTS (grams)

| | | | | | | | | |
|---|---|---|---|---|---|---|---|---|
| SILRES HP 2000 ¹⁹ | 72.64 | 97.13 | 97.35 | 89.26 | 89.26 | 97.13 | 96.59 | 62.50 |
| NIAX CATALYST U-220 ¹⁶ | 1.44 | 1.18 | | 1.37 | 1.37 | 1.18 | 1.47 | |
| K-KAT XC-9213 ²⁰ | | | 1.18 | | | | | |
| Zinc octanoate 8% | | 1.47 | 1.47 | 1.37 | 1.37 | 1.47 | 1.47 | |
| t-Butyl acetate | 14.67 | 0.22 | | 7.99 | 7.99 | 0.22 | | |
| FLIO6W CLEAR | | | | | | | 0.47 | 14.84 |
| COMPONENT B ²¹ | | | | | | | | |
| PRIFER 6813 ¹⁵ | 11.26 | | | | | | | 22.65 |

¹ Epoxy-polysiloxane resin produced according to U.S. Pat. No. 9,493,675
² Hydrogenated BPA type epoxy resin available from Kukdo Chemical Co. Ltd., Seoul, Korea.
³ Epoxy resin (product of epichlorohydrin and BPA) available from Dow Chemical Company, Midland, MI.
⁴ Hindered amine light stabilizer available from BASF
⁵ Proprietary acrylic terpolymer produced by Comex Industrial Coatings, Mexico City, MX
⁶ Antifoamant available from Munzing NA, Bloomfield, NJ
⁷ Leveling additive available from BYK, Wallingford, CN
⁸ Wetting and dispersing additive available from BYK, Wallingford, CN
⁹ Treated fumed silica available from Degussa Evonik Industries, Parsippany, NJ
¹⁰ Leveling agent available from King Industries, Norwalk, CT
¹¹ Tetraethyl orthosilicate available from Degussa Evonik Industries, Parsippany, NJ
¹² Bifunctional organosilane available from Degussa Evonik Industries, Parsippany, NJ
¹³ Silicone polyacrylate resin available from Degussa Evonik Industries, Parsippany, NJ
¹⁴ Leveling additive available from Degussa Evonik Industries, Parsippany, NJ
¹⁵ Plasticizer available from Croda USA, New Castle, DE
¹⁶ Dibutyltin diacetyl acetonate catalyst available from Momentive Performance Materials, Waterford, NY
¹⁷ Polyamide available from Arkema King, Prussia, PA
¹⁸ Lactate ester solvent available from Purac, Lincolnshire, IL
¹⁹ Polysiloxane available from Wacker Silicones, Adrian, MI
²⁰ Zirconium catalyst available from King Industries, Norwalk, CT
²¹ Non-isocyanate curing agent available from Hybrid Coating Technologies, Inc., Daly City, CA

The compositions produced in Examples 1-7 and Comparative Example A were tested for suitability as dry-erasable coating compositions as follows. For each Example, two parts resin component and one part cure component were mixed together. The mixture was applied by rolling and/or spraying onto previously coated pieces of gypsum board and allowed to dry. The pieces of gypsum board were previously coated with a vinyl-acrylic conventional architectural paint. If the dried coating exhibited acceptable coverage, leveling, and appearance, marks were made on the dried coating using various common commercial dry erase markers 24 hours after the coating was applied to the gypsum board. The dry-erase capability was evaluated by erasing a first section of each mark. If the marks were totally erased without ghosting, a second section of each mark was erased at 48 hours. A third section was erased at 72 hours. Subsequently, weekly erasure evaluations were conducted for at least one month. The coating compositions were applied onto gypsum boards and/or cement walls to evaluate their use on common vinyl-acrylic paints.

Each of the cured coatings produced from the coating compositions of Examples 1-7 passed dry-erasability testing in which a portion of the cured coating was subjected to over at least 1000 cycles of writing with an erasable marker (including the commercially available markers EXPO®, QUARTEST®, BIC®, PELIKAN®, FORAY®, OFFICE DEPOT®, SKETCH®, MAGISTRAL®) and erasing with a cloth the same location with no ghost marking remaining after erasing. A coating produced on a substrate with the composition of Comparative Example A that did not include the epoxy-polysiloxane resin could not be written onto with a marker.

### Example 8

To evaluate the field performance of the coating composition produced in Example 6, the coating composition was applied by roller and/or spray onto gypsum boards and/or cement walls and allowed to cure. Marks were made on the coating using common commercial dry erase markers of diverse colors, including the commercially available markers EXPO®, QUARTEST®, BIC®, PELIKAN®, FORAY®, OFFICE DEPOT®, SKETCH®, MAGISTRAL®), four days after the coating was applied. The dry-erasability was evaluated erasing a first section of each mark after 24 hours that the marks were made. Second, third and fourth sections of each mark were erased at 48 hours, 72 hours and three months, respectively, after the marks were made. The results of the evaluation of the coating composition of the Example 6 are summarized in the Table 2.

TABLE 2

| | After 24 hours (1 day) | | | | | | | After 48 hours (2 days) | | | | | | |
|---|---|---|---|---|---|---|---|---|---|---|---|---|---|---|
| Marker | Marker* | | | | | | | Marker | | | | | | |
| Color | 1 | 2 | 3 | 4 | 5 | 6 | 7 | 1 | 2 | 3 | 4 | 5 | 6 | 7 |
| Black | >E | >E | OK | >E | OK | — | OK | >E | >E | OK | >E | OK | — | OK |
| Red | >E | >E | OK | OK | OK | OK | — | >E | >E | OK | OK | OK | OK | — |
| Orange | — | — | — | — | — | OK | — | — | — | — | — | — | OK | — |
| Blue | OK | OK | OK | OK | OK | — | — | OK | >E | OK | OK | OK | — | — |
| Green | OK | >E | OK | >E | OK | — | — | OK | >E | OK | >E | OK | — | — |

| | |
|---|---|
| After 72 hours (3 days) | After 3 months |
| Marker | Marker |

| | 1 | 2 | 3 | 4 | 5 | 6 | 7 | 1 | 2 | 3 | 4 | 5 | 6 | 7 |
|---|---|---|---|---|---|---|---|---|---|---|---|---|---|---|
| Black | >E | >E | OK | >E | OK | — | OK | >E | >E | OK | >E | OK | — | OK |
| Red | >E | >E | OK | OK | OK | OK | — | >E | >E | OK | OK | OK | OK | — |
| Orange | — | — | — | — | — | OK | — | — | — | — | — | — | OK | — |
| Blue | OK | >E | OK | OK | OK | — | — | OK | >E | OK | OK | OK | — | — |
| Green | OK | >E | OK | >E | OK | — | — | OK | >E | OK | >E | OK | — | — |

*various markers used
OK: Excellent erasability; the section of the mark was completely removed without effort.
>E: Excellent erasability; the section of the mark was completely removed with slight effort.

In view of the foregoing description and examples the present invention thus relates inter alia to the subject matter of the following clauses though being not limited thereto.

Clause 1: A curable dry-erasable coating composition comprising: (a) a resin component comprising (i) an epoxy silane resin; and (ii) a cycloaliphatic epoxy resin different from the resin of (a)(i); and (b) an amino-functional crosslinking agent.

Clause 2: The composition of clause 1, wherein the epoxy silane resin component (a)(i) comprises a cycloaliphatic epoxy silane obtained from the reaction of an epoxy functional silane and a hydrogenated bisphenol.

Clause 3: The composition of clause 1 or 2, wherein the epoxy silane resin component (a)(i) further comprises a cycloaliphatic epoxy silane obtained for the reaction of an epoxy functional silane, a hydrogenated bisphenol, and an alkoxy silane.

Clause 4: The composition of any of clauses 1-3, wherein the amino-functional crosslinking agent comprises amino-functional polysiloxane.

Clause 5: The composition of any of clauses 1-4, wherein the amino-functional crosslinking agent further comprises a hydroxyl alkyl urethane.

Clause 6: The composition of any of clauses 1-5, wherein the resin component (a) comprises between 40 to 80 wt. % of the composition based on total solids.

Clause 7: The composition of any of clauses 1-6, wherein the epoxy silane resin (a)(i) comprises between 5 to 50 wt. % of the composition based on total solids.

Clause 8: The composition of any of clauses 1-7, wherein the cycloaliphatic resin (a) (ii) comprises between 10 to 35 wt. % of the composition based on total solids.

Clause 9: The composition of any of clauses 1-8, wherein the composition is substantially free of isocyanate groups.

Clause 10: The composition of any of clauses 1-9, wherein when the composition is applied to a substrate, cured and marked with a marking material comprising a solvent and pigment, the marking material is erasable from the cured coating composition to be substantially invisible.

Clause 11: A coated substrate at least partially coated with the dry-erasable coating composition of any of clauses 1-10.

Clause 12: The coated substrate of clause 11, wherein the substrate comprises wood, cement, fiber cement, gypsum, fiber board, particle board, cellulose-based board, fabric, optionally at least partially coated with a coating composition underlying at least a portion of the dry-erasable coating composition.

Clause 13: The coated substrate of clause 11 wherein the underlying coating composition comprises resins having acrylic, vinyl, styrene, epoxy and/or polysiloxane groups.

Clause 14: A method of making a dry-erasable surface comprising applying the coating composition of clauses 1-10 to at least a portion of a substrate and allowing the coating composition to cure.

Clause 15: The method of clause 14 wherein the substrate further comprises a first coating composition applied to least a portion of the substrate and cured to produce a coated substrate and wherein the coating composition of any of clauses 1-10 is applied to at least a portion of the coated substrate.

Whereas particular embodiments of this invention have been described above for purposes of illustration, it will be evident to those skilled in the art that numerous variations of the details of the present invention may be made without departing from the invention.

The invention claimed is:

1. A curable dry-erasable coating composition comprising: (a) a resin component comprising (i) an epoxy silane resin; and (ii) a cycloaliphatic epoxy resin different from the resin of (a)(i); and (b) an amino-functional crosslinking agent.

2. The composition of claim 1, wherein the epoxy silane resin component (a)(i) comprises a cycloaliphatic epoxy silane obtained from the reaction of an epoxy functional silane and a hydrogenated bisphenol.

3. The composition of claim 2, wherein the epoxy silane resin component (a)(i) further comprises a cycloaliphatic epoxy silane obtained for the reaction of an epoxy functional silane, a hydrogenated bisphenol, and an alkoxy silane.

4. The composition of claim 1, wherein the amino-functional crosslinking agent comprises amino-functional polysiloxane.

5. The composition of claim 4, wherein the amino-functional crosslinking agent further comprises a hydroxyl alkyl urethane.

6. The composition of claim 1, wherein the resin component (a) comprises between 40 to 80 wt. % of the composition based on total solids.

7. The composition of claim 1, wherein the epoxy silane resin (a)(i) comprises between 5 to 50 wt. % of the composition based on total solids.

8. The composition of claim 1, wherein the cycloaliphatic resin (a) (ii) comprises between 10 to 35 wt. % of the composition based on total solids.

9. The composition of claim 1, wherein the composition is substantially free of isocyanate groups.

10. The composition of claim 1, wherein when the composition is applied to a substrate, cured and marked with a marking material comprising a solvent and pigment, the marking material is erasable from the cured coating composition to be substantially invisible.

11. A coated substrate at least partially coated with the coating composition of claim 1.

12. The coated substrate of claim 11, wherein the substrate comprises wood, cement, fiber cement, gypsum, fiber board, particle board, cellulose-based board, and/or fabric.

13. The coated substrate of claim 11, wherein the substrate includes a cured coating composition at least partially underlying the dry-erasable coating composition of claim 1.

14. A method of making a dry-erasable surface comprising applying the dry-erasable coating composition of claim 1 to at least a portion of a substrate and allowing the dry-erasable coating composition to cure.

15. The method of claim 14 wherein the substrate further comprises a first coating composition applied to least a portion of a substrate and cured to produce a coated substrate and wherein the dry-erasable coating composition of claim 1 is applied to at least a portion of the coated substrate.
